(19) United States
(12) Patent Application Publication
(10) Pub. No.: US 2007/0158173 A1
(43) Pub. Date: Jul. 12, 2007

(54) Switches

(75) Inventor: Chistopher John Andrew Barnado, Herfordshire (GB)

Correspondence Address: SUTHERLAND ASBILL & BRENNAN LLP, 999 PEACHTREE STREET, N.E., ATLANTA, GA, 30309, US

(73) Assignee: PELIKON LIMITED, Caerphilly (UK)

(21) Appl. No.: 10/598,141

(22) PCT Filed: Feb. 21, 2005
(86) PCT No.: PCT/GB05/00600

§ 371 Date: Jan. 16, 2007

(30) Foreign Application Priority Data
Feb. 20, 2004 (GB) 0403854.3

(51) Int. Cl. H01H 1/10

(52) U.S. Cl. 200/512

(57) ABSTRACT

A membrane switch comprising a flexible membrane (32, 38, 138) forming a movable part of the switch, the flexible membrane comprising an electroluminescent display (38, 138). More specifically, a switch of the non-latching type, typically for use with a flexible electroluminescent display, which switch comprises: an underlying circuit layer (31, 131) carrying a circuit (34, 35, 134, 135) which the switch is to operate, the circuit being broken by a gap (36, 136) which the switch is to close; a resiliently-deformable contact layer (32, 38, 138), mounted to face the circuit layer's circuit face, the contact layer's circuit-facing surface carrying a conductive bridge portion (37, 137) aligned with the gap, which bridge portion can be resiliently pushed into operative contact with the circuit layer to close the gap therein so long as an applied pushing force (F) is present; and spacing means (33, 133) that keeps the two layers apart in the absence of any applied force pushing them together. The contact layer is typically an electroluminescent display (39, 138). The spacing means is preferably integral with either of the contact or circuit layers, and is advantageously thermoformed in the contact layer.

This invention is concerned with switches, and relates in particular to push-button switches such as those often used to actuate or operate electronic devices such as television remote controllers.

In a “man machine interface” situation pressing a button is an important method of transferring information from the operator (“man”) to the machine. There are many electrical and mechanical arrangements by which the pushing or pressing of a button may cause, or be converted into, a secondary action, and buttons are extensively used as input devices for electronic equipment. The present invention is particularly concerned with electrical and/or electronic buttons used to create an electrical/electronic event that can be measured by a microprocessor-controlled electrical circuit, and thus can be used to trigger another event under that microprocessor control.

In such electronics, the buttons employed are usually of the non latching, or momentary, type, where the momentary (or otherwise) closing of two electrical contacts causes a circuit to be temporarily made, resulting in an electrical event that a microprocessor linked to that circuit can be programmed to use as a trigger to perform some calculation (e.g. to activate a further part of its programme). Typical non latching buttons employed in microprocessor-controlled electrical circuits are the metal dome variety; their construction is in the form of a pressed metal dome, with legs at the periphery, that is arranged on top of a printed circuit board (PCB) so that it is in constant electrical contact with an electrode that is one side of a “broken” electrical circuit (that is, a circuit in which there is a gap across two conductors, which gap is to be bridged by the dome when the switch is actuated). In the traditional (a springy metal or metal-coated plastic) dome construction, when the dome is depressed the centre portion is deflected down and brought into contact with the other side of the broken electrical circuit, completing the circuit for as long as the dome is held deflected. And because the dome is made of a springy material, when the deflection force is removed it springs back to its original domed shape, so breaking electrical contact between the two parts of the electrical circuit.

Some buttons of this type utilise a force concentration layer—a moulded or thermoformed layer—is laid over the dome to reduce the force needed to deflect the dome. Externally) such a moulded plastic layer can take the form of button caps such as those found on mobile phones and in laptop keyboards.

The metal dome button switch is quite an expensive form of construction, and cheaper but as effective structures are always being sought.

Another common type of button is that frequently employed in laminated film keyboard construction. In this type of construction of momentary switch, thin plastic sheets bearing on their facing surfaces the relevant conductive parts of the switch held apart by spacers are laminated together with adhesive so that they are held apart. The facing surface of one of the sheets is printed with electrical conductive paste that when cured forms a electrical circuit with a gap—broken—at a specific point, while the facing surface of the other of the sheets is printed with electrical paste which when cured forms a bridge for the gap, such that when the two sheets are pressed together the electrical circuit on the first sheet is made. Elasticity in the plastic ensures that when a closing force is absent the contacts are not touching, and so the circuit is not made.

In many “traditional” film keypad constructions there are used dome buttons (as described above). Many of these need actuator layers due to the inherent stiffness of the display button laminates. The areas of the actuator layers that can be depressed are localised, and are referred to as buttons or button areas. In some cases an additional layer—a layer of a display-generating material (such as an electroluminescent display layer)—is placed over these button areas, allowing the function of the button to be highlighted (or even changed), increasing the usability of the device of which the keypad forms a part. However, these display layers are commonly relatively thick and stiff by comparison with the underlying dome layer, and as a result their addition tends to deaden the feel of the dome deflection, so as to make it difficult for the User to press, and so removing any feedback that a button-pressing event has occurred.

To overcome this problem it is usual to insert a third “actuator” layer between the display layer and dome layer. The actuator is conveniently a thin layer of plastic that has been thermoformed with small pimples aligned with and facing the centres of the domes; the pimples localise the depression force caused by a pressing finger on the surface of the display layer, so that it is concentrated at the centre of the relevant dome, thus causing a more precise and controlled deflection of the dome with less input force.

The present invention proposes the creation of a novel, and much simpler, type of switch, typically a momentary switch, doing away with both the dome layer and the actuator layer and typically replacing them with an inherently spaced floating “contact (bridge) layer” that can be used to complete the underlying circuit.

According to a first aspect, this invention provides a push, or button, switch which switch comprises:

an underlying circuit layer carrying a circuit which the switch is to operate, the circuit being broken by a gap which the switch is to close;

a resiliently-deformable contact layer, mounted to face the circuit layer's circuit face, the contact layer's circuit-facing surface carrying a conductive bridge portion aligned with the gap, which bridge portion can be resiliently pushed into operative contact with the circuit layer to close the gap therein so long as an applied pushing force is present; and

spacing means that keeps the two layers apart in the absence of any applied force pushing them together,

in which the contact layer comprises an, electroluminescent display.

We have appreciated that electroluminescent displays, which previously have been viewed as too rigid to use as the membrane in membrane-type switches, can be used in switches that do not use domes or the like. Accordingly, a switch according to the present invention provides for a simple switch that can be cheap and easy to manufacture.

The switch is preferably arranged such that a force can be exerted on the contact layer by a user to operate the switch, and most preferably arranged so that a user may exert a force on the electroluminescent display.

The bridge portion may be carried directly on the electroluminescent display. It may be printed onto a reverse side of the display from that which emits light. Alternatively, a discrete contact bridge layer may be provided as part of the contact layer, the contact bridge layer carrying the bridge portion. The contact layer may be considered to be the group of layers that flex together on application on that layer by a user. Preferably, the switch is arranged such that a user can apply a force to the contact layer to actuate the switch.

Preferably the electroluminescent display is of the type comprising a layer of light emitting phosphor sandwiched between two electrodes. One of the electrodes may be an Indium Tin Oxide electrode, which may be substantially transparent.

The invention may conveniently provide a push, or button, switch of the non-latching, momentary, type. Such a switch type is well known, and needs no further comment here.

The invention provides a push (or button) switch. Many such switches may be arranged in some form of array—as the switches of a keypad such as found on a computer, a remote controller or a calculator, for example. The array may contain as many switches as required, and be for any purpose. In such an array each switch is most conveniently an integral part of the array rather than an individual, separate item. Thus, in such an array there is in effect a single, large, circuit layer made of many smaller circuit layers joined integrally together, and similarly there is a single large contact layer made of many smaller contact layers joined integrally together.

Each switch of the invention comprises an underlying circuit layer carrying the circuit which the switch is to operate, the circuit being “broken” by a gap which the switch is to close, together with the contact layer carrying the conductive bridge portion. The layer may be of any appropriate form and of any suitable material, and the circuit can be for any purpose. Typically, the layer plus its circuit is an ordinary Printed Circuit Board (PCB), perhaps with the conductive portions (typically made from plated etched copper PCB tracking) either side of the bridgeable gap being emphasised to facilitate the gaps closure by the bridge, much as those already in use, and no more need be said about that here.

The gap may comprise a physical gap which is bridged or broken by the bridge portion. However, it may be a region which has a resistance which varies depending on the proximity of the bridge portion.

The switch of the invention may include a resiliently-deformable floating contact layer, mounted to face the circuit layer's circuit face, the contact layer's circuit-facing surface carrying a conductive bridge portion aligned with the gap. The contact layer or the contact bridge layer may be “floating” in the sense that over its area it is not secured in any significant way to the circuit layer, but may relatively freely move—slide—laterally with respect thereto. It may, however, be held relative to the circuit layer at its edges, so as to prevent it slipping sideways away from the circuit layer completely. And where there is an array of such switches, with a single, large, circuit layer and a single, large, contact layer, these two large layers may be held together around their peripheries, but may not be secured over their facing areas. Notionally, then, they can slide sideways one relative to the other, though such sideways movement is necessarily restricted.

The contact layer, or contact bridge layer, may be made of a resiliently-deformable (and non conductive) material. Such a material provides the layer with its inherent springiness, enabling deformation of the layer to remain within its elastic modulus such that depressing it to make contact does not deform it plasticly, this allowing the contact layer to return to its rest position, and thus the switch to open, when the pushing force is removed. A typical such material is a thin (0.175 mm or so) sheet of a thermoplastic such as a polyester like polyethylene terephthalate (PET).

The contact layer of the switch of the invention carries on its circuit-facing surface a conductive bridge portion aligned with the gap in the circuit it faces. By pushing on the contact layer this bridge portion can be pushed into operative contact with the circuit layer to close the gap therein so long as the applied pushing force is present. The bridge portion can be made from any suitable material; curable silver paste, as used in conventional conductive printing, is quite satisfactory.

In the switch of the invention spacing means are utilised so that in the absence of an applied pushing force the contact layer is kept apart from the circuit layer—and thus the bridge portion is kept away from the circuit defining the gap, and so the switch is kept open. Very preferably the spacing means is actually integral with one or other of the two layers—rather than being a separate component sandwiched between the two—and 5 most conveniently it is an integral part of the contact layer. The spacing means is most desirably formed into the contact layer, typically by thermoforming, printing, stamping or otherwise as, say, one or more bumps, dents or ridges. Thermoforming is particularly useful where the contact layer is a sheet of plastic (preferably thermoformable thermoplastic).

In an alternative, the spacing means may comprise one or more discrete spacers. The spacers may be provided as a web, which extends over the contact and circuit layers around the gap and the bridge portion.

A single switch most conveniently includes as its spacing means a peripheral ridge (or the like) extending all around the actual b ridge portion, forming a perimeter to that area of the layer. Though many geometrical shapes of periphery are possible, such as circles and nestable shapes like hexagons, plain square ones seems the best. When the switch is but one of an array then similarly the peripheral ridge is but one part of a matching grid of ridges.

The switch of the invention may incorporate an associated display layer. This display layer, which can be of any kind, active or inactive—one preferred such active type is an electroluminescent display layer; an inactive one might simply be conventional key caps—very preferably floats on top of the contact layer much as the latter floats on top of the circuit layer—that is, not glued or otherwise secured thereto over its area but preferably bounded around its edges so as to be prevented from slipping off to the side, and thus lateral displacement.

According to a second aspect of the invention, there is provided a push, or button, switch of the non latching, momentary, type, which switch comprises:

an underlying circuit layer carrying the circuit which the switch is to operate, the circuit being “broken” by a gap which the switch is to close;

a resiliently-deformable floating contact layer, mounted to face the circuit layer's circuit face, the contact layer's circuit-facing surface carrying a conductive bridge portion aligned with the gap, which bridge portion can be resiliently pushed into operative contact with the circuit layer to close the gap therein so long as the applied pushing force is present; and

spacing means that keeps the two layers apart in the absence of any applied force pushing them together.

The switch of the second aspect of the invention may have any of the optional features of the first aspect. Very preferably the spacing means is actually integral with one or other of the contact and circuit layers—rather than being a separate component sandwiched between the two—and most conveniently it is an integral part of the contact layer. Indeed, where the contact layer is a sheet of plastic (preferably thermoformable thermoplastic) material then the spacing means is most desirably formed into it, typically by thermoforming, printing, stamping or otherwise as, say, one or more bumps, dents or ridges.

The switch of the invention may incorporate an associated display layer. This display layer, which can be of any kind, active or inactive—one preferred such active type is an electroluminescent display layer; an inactive one might simply be conventional key caps—very preferably floats on top of the contact layer much as the latter floats on top of the circuit layer—that is, not glued or otherwise secured thereto over its area but preferably bounded around its edges so as to be prevented from slipping off to the side, and thus lateral displacement.

According to a third aspect of the invention, there is provided an array comprising a plurality of switches according to the first or second aspects of the invention, the switches sharing a single common circuit layer and a single common contact layer.

The circuit layer and the contact layer are preferably held together around their peripheries, but are not secured over their facing areas.

According to a fourth aspect of the invention, there is provided a membrane switch comprising a flexible membrane forming a movable part of the switch, the flexible membrane comprising an electroluminescent display. Preferably the electroluminescent display forms a front surface of the switch, whereby a user may apply pressure to the switch to actuate the switch. The switch may be one according to any preceding aspect of the invention, and may have any of the optional features of those aspects.

Embodiments of the invention will now be described, by way of illustration only, with reference to the accompanying diagrammatic Drawings, in which:

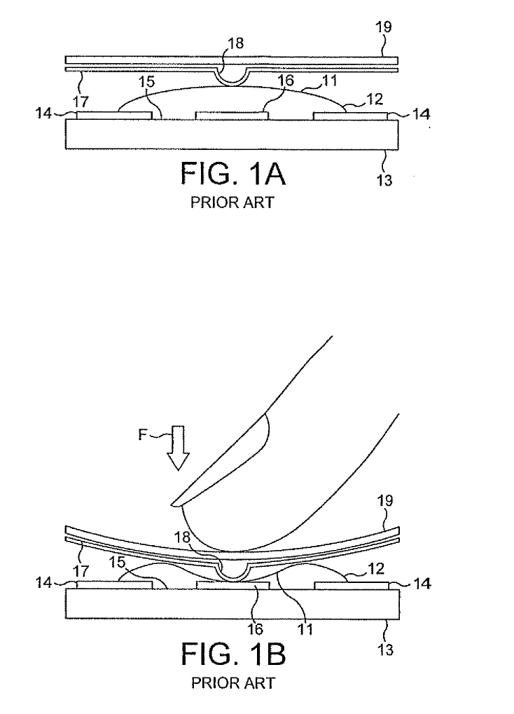

FIGS. 1A & 1D show sectional views through a Prior Art metal dome button switch, respectively open and closed;

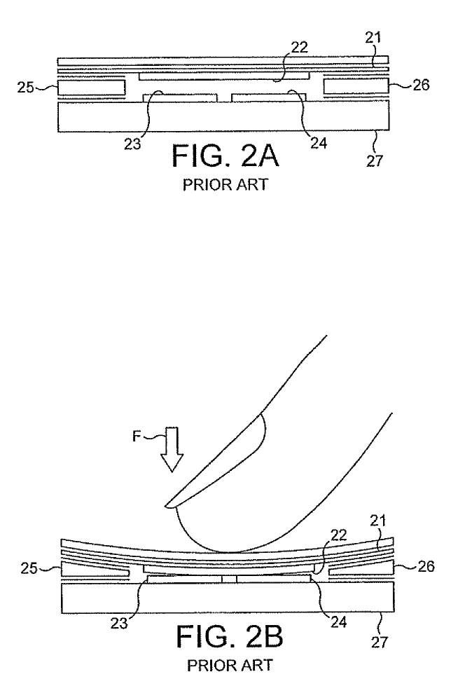

FIGS. 2A & 2B show sectional views through a Prior Art laminated button switch, respectively open and closed;

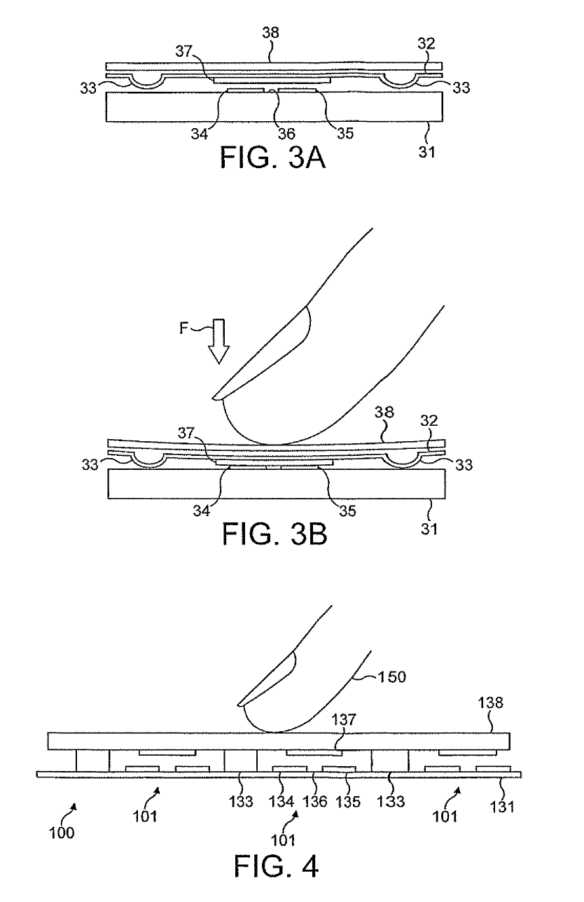

FIGS. 3A & 3B show sectional views through a freely floating button switch according to the invention, respectively open and closed; and

FIG. 4 shows a second embodiment of the switch according to the present invention.

FIGS. 1A & 1B show sectional views through a Prior Art metal dome button switch; in FIG. 1A the switch is shown open, while in FIG. 1B it is shown closed by a finger pushing it.

The switch is of the non latching, or momentary, type, where the momentary (or otherwise) closing of two electrical contacts causes a circuit to be temporarily made. It is of the metal dome variety; it comprises a pressed metal dome (11), with legs (12: usually there are four, but in this section only two can be seen) at the periphery, that is arranged on top of a printed circuit board (PCB 13) so that it is in constant electrical contact with an electrode (14) that is one side of a “broken” electrical circuit (that is, a circuit in which there is a gap (15) across two conductors [14,16], which gap 15 is to be bridged by the dome 11 when the switch is actuated). In the traditional dome construction, when the dome 11 is depressed—as shown in FIG. 1B, by finger pressure (F)—the centre portion 11 is deflected down and brought into contact with the other side 16 of the broken electrical circuit, bridging the gap 15 between the two electrodes 14,16 and so completing the circuit for as long as the dome 11 is held deflected. And because the dome 11 is made of a springy material, when the deflection force F is removed it springs back to its original domed shape, so breaking electrical contact between the two parts 14,16 of the electrical circuit.

The button as shown uses a force concentration layer (17) laid-over the dome 11 to reduce the force needed to deflect the dome. This layer 17 bears a pimple (18) that bears on the dome 11, and so ensures that all the force F provided by finger pressure is actually concentrated on, and applied to, the dome. The button also has an overlying layer (19) representing a button cap or the like.

Another common type of button is that shown in FIGS. 2A & 2B. In this type, a thin plastic sheet (21) bears on its PCB facing surface the conductive bridge part (22) of the switch which is held away from the PCB carrying circuit portions (electrodes 23,24) by spacers (25,26), and the sheet 217 PCB (27) and the spacers 25,26 are all laminated together with adhesive. When the sheet 21 is pressed (F) down onto the PCB, the bridge 22 joins the two electrodes 23,24 and makes the PCB's electrical circuit. Elasticity in the plastic of the sheet 21 ensures that when a closing force F is absent the contacts 22,23,24 are not touching, and so the circuit is not made.

FIGS. 3A & 3B show sectional views through a freely floating button switch according to a first embodiment of the invention, respectively open and closed.

There is shown a push, or button, switch of the non latching, momentary, type. The switch comprises an underlying circuit layer (PCB 31), a resiliently-deformable floating contact layer (32), mounted to face the circuit layer's circuit face, and spacing means (33) that keep the two layers 31,32 apart in the absence of any applied force (F) pushing them together. This switch is now described in more detail as though it were on its own; however, in a real situation this switch would be merely one of an array of like switches, each of which can be operated independently of all the others.

The PCB circuit layer 31 carries the circuit which the switch is to operate. The circuit is not fully shown here, but has two spaced electrodes (34,35) defining a gap (36) which the switch is to close. The contact layer 32, mounted to face the circuit layers circuit face, carries on its face toward the circuit a conductive bridge portion (37) aligned with the gap. The bridge portion 37 can be pushed (by force F) into operative contact with the electrodes 34,35 of the circuit layer 31 so as to close the gap 36. The spacing means 33 keeps the two layers 31,32 apart—and thus the gap 36 unbridged, and so the circuit “open”—in the absence of any applied force F pushing them together.

The contact layer 32 may be made by a thermoforming operation on a single layer of material, to provide both spacing and electrical contacts in one piece. It is manufactured from a thermoplastic film, typically around 0.175 mm thick. On one surface the film is printed with electrically-conductive paste (a silver- or carbon-loaded polymer binder), in a bridge pattern 37 that will in use align with the electrode contact areas 34,35 laid out on the PCB 31. The film is then thermoformed to provide small ridges 33 around the contact area—in an array of like switches these would be between adjacent contact areas. These ridges form spacers, so that when the contact layer film 32 is resting on the PCB 31 the film's conductive bridge part(s) 37 are not in contact with the PCB's contact areas 34,35.

The degree of deformation required by thermoforming material of the contact layer 32 in order for it to act as an adequate spacer is related to the material thickness and to the desired spacing between the buttons. Typically, however, it is of the order of the thickness of the material itself (thus, around 0.175 mm).

In this construction, which is in accordance with the invention, the contact layer 32 is also the spacer layer, thus saving not only an entire manufacturing operation but also the adhesive component necessary in the traditional construction of a film keyboard (as described above with reference to FIGS. 2).

FIG. 3B shows the button of the invention being pressed and making contact between the two circuit elements 34735 on the PCB 31. It is important to note that the contact layer 32 floats in the “sandwich” structure depicted, and is not rigidly adhered to either the PCB 31 or to a display layer (38) comprising an Electroluminescent display layer positioned above the contact layer. This floating means that there is avoided the detrimental increase in stiffness that would result from laminating (bonding) the display layer 38 to the contact layer 32, and then gluing the assembly to the PCB 31, which stiffness would render the buttons very difficult to press, as the force necessary to close the contacts would be increased beyond what would be practical.

Of course, although the contact layer 32 is not fixed by adhesive in the construction to either the display layer 38 or the PCB layer 31, but is instead allowed to “float” vertically (that is, in button-pushing alignment) between the PCB and the display layers, nevertheless it is held in place horizontally/laterally by some means (not shown here, but it could be, for example, heat stakes, location pins, mating holes in the PCB corresponding to thermoformed lugs in the contact layer, or edge to edge contact), so that the contact bridge areas 37 are always maintained in the correct positions in lateral alignment with the PCB 31.

This novel construction allows the contact layer 32 to deflect minutely in the horizontal plane—laterally—as well as in the vertical plane when pressing force F is applied to the display layer 38, so greatly reducing the actuation force necessary for adequate deflection. This novel construction also allows the thermoformed spacing part 33 of the layer 32 to be as thin as possible, reducing the deflection needed to actuate the button and make contact, and thereby reducing the stress on the display layer 38 due to deformation, and so increasing its performance life, and the ease with which the switch is closed by the User.

FIG. 4 of the accompanying drawings shows a second embodiment of a switch according to the present invention. Features common to the embodiment shown in FIGS. 3A and 3B of the accompanying drawings have been indicated with the same reference numerals, raised by 100.

The Figure shows an array 100 of switches 101 sharing a common PCB 131. Each switch 101 (only one of which is referenced in detail in the Figure) comprises as previously a pair of electrodes 134, 135 spaced by a gap 136. Instead of the contact layer 32 of the previous embodiment, the array is provided only with an electroluminescent (EL) layer 138 which itself performs the functions of the contact layer. On this EL layer 138 is printed the conductive bridge portion 137 that can be brought into contact with electrodes 133, 135 to bridge gap 136 on application of pressure by a user 150.

Spacers 133 are provided to keep the bridge portion 137 away from the electrodes 134, 135 when the user 150 is not applying pressure. In this case, the spacers are provided as discrete units, which also serve to fix the EL layer 138 relative to the circuit layer 131 The spacers 133 form a web surrounding the electrodes 134, 135 of each switch 101, so as to describe a mesh. However, the spacers 133 could also comprise an integral part of circuit layer 131 or EL display 138, by printing or forming the appropriate layer with a section which spaces one layer from the other in the absence of pressure on the display 138.

1. (canceled)

2. (canceled)

3. A push or button switch comprising:
an underlying circuit layer carrying a circuit, the circuit being broken by a gap;
a resiliently-deformable contact layer having a conductive bridge portion on a surface thereof, the contact layer mounted such that the conductive portion is aligned with the gap, which bridge portion can be resiliently pushed into operative contact with the circuit layer to close the gap therein so long as an applied pushing force is present;
spacing means that keeps the two layers apart in the absence of any applied force pushing them together, in which the spacing means is integral with one or other of the contact layer and circuit layer, and
an electroluminescent display layer positioned above the contact layer.

4. (canceled)

5. (canceled)

6. (canceled)

7. (canceled)

8. (canceled)

9. (canceled)

10. (canceled)

11. The switch according to claim 3 in which the spacing means is an integral part of the contact layer.

12. The switch according to claim 11 in which the spacing means is formed into the contact layer.

13. The switch according to claim 11 in which the spacing means is formed into the contact layer or the circuit layer by thermoforming, stamping as one or more bumps, dents or ridges.

14. (canceled)

15. (canceled)

16. (canceled)

17. (canceled)

18. (canceled)

19. (canceled)

20. (canceled)

21. The switch according to claim 11 in which the spacing means in formed into the contact layer or the circuit layer by printing as one or more bumps, dents or ridges.

22. The switch according to claim 3, in which the switch is arranged such that force can be exerted on the contact layer by a user to operate the switch.

23. The switch according to claim 22, arranged so that a user exerts a force on the electroluminescent display layer to exert a force on the contact layer.

24. The switch according to claim 3 in which the contact layer is held relative to the circuit layer at its edges, so as to prevent it slipping sideways away from the circuit layer.

25. The switch according to claim 3, comprising a peripheral ridge extending all around the bridge portion, forming a perimeter to that area of the layer.

26. The switch according to claim 3, in which the spacing means comprises at least one discrete spacer.

27. An array comprising a plurality of switches according to claim 3.

28. The array according to claim 27 wherein, the switches share a single common circuit layer and a single common contact layer.

29. The array according to claim 27, in which the circuit layer and the contact layer are held together around their peripheries, but are not secured over their facing areas.
